(19) United States
(12) Patent Application Publication
(10) Pub. No.: US 2024/0396283 A1
(43) Pub. Date: Nov. 28, 2024

(54) ALL FIBER ADJUSTABLE BEAM SHAPING

(71) Applicant: nLIGHT, Inc., Camas, WA (US)

(72) Inventors: Brendan G. O'DEA, Portland, OR (US); Roger L. Farrow, Vancouver, WA (US); Juan Carlos LUGO, Vancouver, WA (US); Brian M. VICTOR, Camas, WA (US); Dahv A.V. Kliner, Portland, OR (US)

(21) Appl. No.: 18/671,923

(22) Filed: May 22, 2024

Related U.S. Application Data
(60) Provisional application No. 63/503,924, filed on May 23, 2023.

(51) Int. Cl. H01S 3/067; H01S 3/00

(52) U.S. Cl. CPC H01S 3/06791; H01S 3/005; H01S 3/06729

(57) ABSTRACT

A method of generating adjustable composite beam shapes in response to controllable perturbation includes receiving, via inputs of multiple input fibers, different laser beams, combining the outputs from the multiple input fibers into a divergence-preserving fiber that preserves a combined divergence distribution of the intermediate beams; and converting at an output lens the combined divergence distribution to an output transverse spatial intensity distribution defining a composite beam shape of an output beam. The output transverse spatial intensity distribution includes a superposition of individual channel output beams. At least one of the multiple input fibers has a tunable fiber assembly with a series of first, second, and third portions that adjust an input transverse spatial intensity distribution in response to controllable perturbation, convert the input transverse spatial intensity distribution to an intermediate divergence distribution, and preserve the intermediate divergence distribution that is delivered to the fused fiber combiner.

### RELATED APPLICATIONS

This US Non-Provisional Patent Application relies for priority on U.S. Provisional Patent Application Ser. No. 63/503,924, entitled “ALL FIBER ADJUSTABLE BEAM SHAPING,” filed May 23, 2023, the entire content of which is hereby incorporated by reference.

This application relates to International Application No. PCT/US2022/080460, filed Nov. 23, 2022, which claims priority benefit of U.S. Provisional Patent Application No. 63/264,574, filed Nov. 24, 2021, the disclosures of which are hereby incorporated by reference herein in their entireties.

### TECHNICAL FIELD

The technology disclosed herein relates to fiber lasers and fiber-coupled lasers. More particularly, the disclosed technology relates to methods, apparatuses, and systems including a fiber assembly for generating adjustable beam shapes.

### BACKGROUND INFORMATION

As described in U.S. Pat. No. 10,423,015, titled “Adjustable Beam Characteristics,” and its related patents, nLIGHT, Inc. developed technology for varying beam properties by controlling a spatial intensity distribution of a laser beam, i.e., adjusting its near-field transverse spatial intensity distribution.

The '015 patent describes a fiber operable to provide a laser beam having variable beam characteristics (VBC) that may reduce cost, complexity, optical loss, or other drawbacks of the conventional methods. This VBC device is configured to vary a wide variety of optical beam characteristics. Such beam characteristics can be controlled using the VBC device thus allowing users to tune various beam characteristics to suit the particular requirements of an extensive variety of laser processing applications. For example, a VBC device may be used to tune any of the following: beam diameter, divergence distribution, BPP, intensity distribution, M² factor, NA, power density, radial beam position, radiance, spot size, or the like, or any combination thereof.

In some embodiments, the '015 patent describes adjusting the coupling of the beam into a so-called ring fiber, which has two or more separate guiding regions. A ring fiber has one or more annular cores optionally surrounding a central (non-annular) core, with low-index glass layers separating the cores so that light coupled into a core will be guided in that core without significant coupling to the other core(s). To achieve a variety of beam diameters and shapes using embodiments and techniques described in the '015 patent, it is possible to divide the spatial intensity distribution of a laser beam coupled to a ring fiber between the two or more guiding regions of the fiber. This approach causes a portion of the beam to overlap with the low-index layer(s) separating the guiding regions, resulting in increased divergence. This increased divergence is undesirable for some applications, e.g., it can cause overheating of some process optics.

### SUMMARY OF THE DISCLOSURE

This disclosure describes techniques of generating structured beam shapes. Various terms may be used to describe these beam shapes. A beam shape in which all or nearly all of the power is contained in a ring may be called a “ring beam.” A beam shape comprising a ring with non-zero intensity in the center of the ring may be called a “saddle beam.” A beam shape comprising a central spot surrounded by one or more lower-intensity rings or “halos” may be called a “pedestal beam.” A beam shape in which the intensity of the central beam and the surrounding ring or rings is similar may be called a “flat-top beam.” These structured beam shapes may be generated from a single input beam, or they may be generated by combining multiple input beams into a “composite” output beam shape. In the latter case, each input beam generates a particular output beam shape, and the net output beam shape is the sum of these individual output shapes (generated by, in effect, overlapping the multiple output beam shapes). In some embodiments, the composite beam shapes are comprised of one of more ring-shaped beams and an optional central beam. Note that these descriptions are qualitative and are not meant to be exclusive (i.e., other beam shapes are possible, multiple methods can be used to generate a particular beam shape, and a given beam shape can have multiple names in the literature). In keeping with standard practice, this disclosure uses these terms qualitatively.

Industrial laser welding has seen widespread adoption, in part due to the ability to control the properties of the weld through carefully selected laser intensity distributions. One common laser beam shape employed in industrial welding is a central Gaussian or flat-top beam with a surrounding ring beam. By varying the power in the central beam and the power in the ring beam independently, properties of the weld such as the welding mode (conduction versus keyhole), weld depth, and features related to the weld melt pool dynamics (smoke, spatter, porosity, process stability) can be optimized for a given application. Existing laser welding systems achieve these beam shapes by coupling one or more laser sources to the central core and ring guiding regions of an optical fiber (ring fiber). Some examples of typical central core diameter and ring outer diameter include 50/180, 50/300, 100/400, and 200/600 (diameters in microns). The limitation of the existing approach is that the dimensions of the central core and ring are fixed. In lasers systems with such fibers, adjusting the relative sizes of the core and ring beams is only possible by changing the fiber. The inability to adjust the spatial intensity distribution by adjusting the relative dimensions of the central core and the ring restricts further optimization of the laser welding process and limits the versatility of these laser systems.

In one aspect, an optical beam delivery system generates adjustable composite beam shapes in response to controllable perturbation. The system includes multiple input fibers, each of which is configured to receive at its input a different laser beam and to provide at its output a corresponding intermediate beam. The system also includes a fused fiber combiner configured to couple outputs from the multiple input fibers into a divergence-preserving fiber that preserves a combined divergence distribution of the intermediate beams. An output lens is configured to convert the combined divergence distribution to an output transverse spatial intensity distribution defining a composite beam shape of an output beam. The output transverse spatial intensity distribution includes a superposition of individual output beams corresponding to the multiple input fibers. At least one of the multiple input fibers has a tunable fiber assembly. The tunable fiber assembly includes a series of first, second, and third portions. The first portion is configured to adjust an input transverse spatial intensity distribution in response to the controllable perturbation. The second portion is configured to convert the input transverse spatial intensity distribution to an intermediate divergence distribution. The third portion is configured to preserve the intermediate divergence distribution that is delivered to the fused fiber combiner.

The foregoing and other objects, features, and advantages will become more apparent from the following detailed description, which proceeds with reference to the accompanying figures, which may not be drawn to scale.

### BRIEF DESCRIPTION OF THE DRAWINGS

To easily identify the discussion of any particular element or act, the most significant digit or digits in a reference number refer to the figure number in which that element is first introduced.

FIG. 1 is a side view of an optical beam delivery device including a bendable ¼ pitch length of GRIN fiber, a divergence-preserving length of fiber, and a straight GRIN length of fiber, according to a first embodiment.

FIG. 2 is a beam propagation simulation plot (propagation direction is from left to right along a Z axis) for the embodiment of FIG. 1, showing a mode field in an X-Z plane as the beam propagates through the bent GRIN fiber.

FIG. 3 is a plot of a simulated angular intensity distribution at an output of the bendable ¼-pitch GRIN fiber for the system shown in FIG. 1 when bendable GRIN fiber is straight, in which the upper frame is a two-dimensional (X, Y) plot of the angular intensity distribution, and the lower frame is a one-dimensional (X, Y=0) plot through the angular intensity distribution.

FIG. 4 is a plot of a simulated angular intensity distribution at an output of the bendable ¼-pitch GRIN fiber for the system shown in FIG. 1 when bendable GRIN fiber is bent, in which the upper frame is a two-dimensional (X, Y) plot of the angular intensity distribution, and the lower frame is a one-dimensional (X, Y=0) plot through the angular intensity distribution.

FIG. 5 is a plot of an experimentally measured angular intensity distribution at an output of the divergence-preserving fiber for the system shown in FIG. 1 when bendable GRIN fiber is straight, in which the upper frame is a two-dimensional (X, Y) plot of the angular intensity distribution, and the lower frame is a one-dimensional (X, Y=0) plot through the angular intensity distribution.

FIG. 6 is a plot of an experimentally measured angular intensity distribution at an output of the divergence-preserving fiber for the system shown in FIG. 1 when bendable GRIN fiber is bent, in which the upper frame is a two-dimensional (X, Y) plot of the angular intensity distribution, and the lower frame is a one-dimensional (X, Y=0) plot through the angular intensity distribution.

FIG. 7 is a plot of a simulated near-field transverse spatial intensity distribution at an output of the second ¼-pitch GRIN fiber for the system shown in FIG. 1 when the bendable GRIN fiber is straight, in which the upper frame is a two-dimensional (X, Y) plot of the intensity distribution, and the lower frame is a one-dimensional (X, Y=0) plot through the intensity distribution.

FIG. 8 is a plot of a simulated near-field transverse spatial intensity distribution at an output of the second ¼-pitch GRIN fiber for the system shown in FIG. 1 when the bendable GRIN fiber is bent, in which the upper frame is a two-dimensional (X, Y) plot of the intensity distribution, and the lower frame is a one-dimensional (X, Y=0) plot through the intensity distribution.

FIG. 9 is a side view of an optical beam delivery device including multiple lengths of optical fiber, according to a second embodiment.

FIG. 10 is a side view of an optical beam delivery device including multiple lengths of optical fiber, according to a third embodiment.

FIG. 11 is a side elevation view of an optical beam delivery device including a mode-scrambling portion, according to one embodiment.

FIG. 12 is a side elevation view of an optical beam delivery device including a mode-scrambling portion, according to one embodiment.

FIG. 13 is a side elevation view of an optical beam delivery device including a mode-scrambling portion, according to one embodiment.

FIG. 14 is a side view of an optical beam delivery device including multiple lengths of optical fiber, according to a fourth embodiment.

FIG. 15 is a flow chart showing a method of modifying an angular intensity distribution of an input beam so that it is converted to an output beam having an adjustable near-field transverse spatial intensity distribution in accordance with one embodiment.

FIG. 16 is a side elevation view of an optical beam delivery system for selectively generating different composite beam shapes, according to one embodiment.

FIG. 17 is a plot of an experimentally produced near-field transverse spatial intensity distribution at an output of the output ¼-pitch GRIN fiber for the system shown in FIG. 16 when a first input fiber and a second input fiber generate nearly completely overlapping beams because a bendable GRIN fiber of the second input fiber is straight, in which the upper frame is a two-dimensional (X, Y) plot of the intensity distribution, and the lower frame is a one-dimensional (X, Y=0) plot through the intensity distribution.

FIG. 18 is a plot of an experimentally produced near-field transverse spatial intensity distribution at an output of the output ¼-pitch GRIN fiber for the system shown in FIG. 16 when a first input fiber and a second input fiber generate decreasingly overlapping beams as a bendable GRIN fiber of the second input fiber is slightly bent, in which the upper frame is a two-dimensional (X, Y) plot of the intensity distribution, and the lower frame is a one-dimensional (X, Y=0) plot through the intensity distribution.

FIG. 19 is a plot of an experimentally produced near-field transverse spatial intensity distribution at an output of the output ¼-pitch GRIN fiber for the system shown in FIG. 16 when a first input fiber and a second input fiber generate substantially spatially separated beams as a bendable GRIN fiber of the second input fiber is increasingly bent, in which the upper frame is a two-dimensional (X, Y) plot of the intensity distribution, and the lower frame is a one-dimensional (X, Y=0) plot through the intensity distribution.

FIG. 20 is a plot of an experimentally produced near-field transverse spatial intensity distribution at an output of the output ¼-pitch GRIN fiber for the system shown in FIG. 16 when a first input fiber and a second input fiber generate increasingly spatially separated beams because a bendable GRIN fiber of the second input fiber is fully bent, in which the upper frame is a two-dimensional (X, Y) plot of the intensity distribution, and the lower frame is a one-dimensional (X, Y=0) plot through the intensity distribution.

FIG. 21 is a side elevation view of an optical beam delivery system for selectively generating different composite beam shapes, according to one embodiment.

FIG. 22 is a plot of an experimentally produced near-field transverse spatial intensity distribution at an output of the output ¼-pitch GRIN fiber for the system shown in FIG. 21 when a third input fiber is guiding a beam, in which the upper frame is a two-dimensional (X, Y) plot of the intensity distribution, and the lower frame is a one-dimensional (X, Y=0) plot through the intensity distribution.

FIG. 23 is a flow chart of a process in accordance with one embodiment.

### DETAILED DESCRIPTION OF EMBODIMENTS

### Introduction

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems, apparatuses, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatuses are not limited to any specific aspect or feature or combinations thereof, nor do the disclosed systems, methods, and apparatuses require that any one or more specific advantages be present, or problems be solved. Any theories of operation are to facilitate explanation, but the disclosed systems, methods, and apparatuses are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatuses can be used in conjunction with other systems, methods, and apparatuses. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by skilled persons.

In some examples, values, procedures, or apparatuses are referred to as “lowest,” “best,” “minimum,” or the like. It will be appreciated that such descriptions are intended to indicate that a selection among many used functional alternatives can be made, and such selections need not be better, smaller, or otherwise preferable to other selections. Examples are described with reference to directions indicated as “above,” “below,” “upper,” “lower,” and the like. These terms are used for convenient description, but do not imply any particular spatial orientation. Moreover, in the following examples, laser components and assemblies are described at a high level of abstraction and do not include a complete description of all mechanical, electrical, and optical elements necessary for operation.

As used herein, optical radiation refers to electromagnetic radiation at wavelengths of between about 100 nm and 10 μm, and typically between about 200 nm and 2 μm. Examples based on available laser diode and fiber laser sources and optical fibers generally are associated with wavelengths of between about 800 nm and 2,000 nm. In some examples, propagating optical radiation is referred to as one or more beams having diameters, asymmetric fast and slow axes, beam cross-sectional areas, and beam divergences that can depend on beam wavelength and the optical systems used for beam shaping. For convenience, optical radiation is referred to as light or beams in some examples and need not be at visible wavelengths. Forward-propagating light or optical beams or beam portions refer to light, beams, or beam portions that propagate in a direction of normal emission. Backward-propagating light or optical beams or beam portions refer to light, beams, or beam portions that propagate in an opposite direction of normal emission.

### Component Overview

To understand the characteristics of embodiments described in the present disclosure, it is helpful to first understand the underlying components and physical phenomena exploited with the components. Accordingly, the following paragraphs summarize optical fibers and lenses.

Optical fibers: An optical fiber is a thin, flexible strand of material (typically glass) that guides light within a core that is surrounded by a cladding. The core has a higher refractive index than the cladding, causing light to be guided by total internal reflection. The refractive index profile (RIP), i.e., the refractive index as a function of position transverse to the fiber axis, determines many of the important properties of the fiber. Many but not all fibers are cylindrically symmetric (i.e., the index is independent of azimuthal angle about the fiber axis). Optical fibers may have circular, square, rectangular, polygonal, oval, elliptical, or other cross-sections. In some embodiments, the core and claddings are approximately concentric. In other examples, one or more of the cores and claddings are decentered, and in some examples, core and cladding orientation and/or displacement vary along a waveguide length.

Optical fibers are typically formed of silica (glass), and dopants are added to increase or decrease the refractive index. Dopant concentrations are varied transversely to generate the desired RIP. In some examples, fibers or other waveguides are made of other materials such as fluorozirconates, fluoroaluminates, fluoride or phosphate glasses, chalcogenide glasses, or crystalline materials such as sapphire, depending on wavelengths and other properties of interest. Refractive indices of silica and fluoride glasses are typically about 1.5, and refractive indices of other materials such as chalcogenides can be 3 or more. In still other examples, optical fibers can be formed in part or completely of plastics (polymers).

In some examples, a doped waveguide core such as a fiber core provides optical gain in response to pumping. In the examples disclosed herein, a waveguide core such as an optical fiber core is doped with one or more rare-earth elements such as Nd, Yb, Ho, Er, Tm, or other active dopants or combinations thereof. Such actively doped cores can provide optical gain in response to optical pumping. As disclosed below, waveguides having such active dopants can be used to form optical amplifiers, or, if provided with suitable optical feedback such as reflective layers, mirrors, Bragg gratings, or other feedback mechanisms, such waveguides can generate laser emissions. Optical pump radiation can be arranged to co-propagate and/or counter-propagate in the waveguide with respect to a propagation direction of an emitted laser beam or an amplified beam.

Step-index fibers: The most common RIP is known as “step index,” in which the core has a uniform index and is surrounded by the cladding with a uniform (lower) index. In a step-index fiber, light launched into the fiber core in a given location tends to spread radially and azimuthally to fill the core, i.e., the core does not preserve spatial information about the location of the launched beam. It is known that light rays launched at a particular angle with respect to the fiber axis tend to exit the fiber core at the same angle (in a cone because of azimuthal scrambling), i.e., step-index fibers typically preserve angular information. In particular, the preservation of the launch angle at the output of the step-index fiber (i.e., the far-field divergence profile) is a property leveraged by embodiments of this disclosure. (Note that the terms far- and near-field intensity distribution mean, respectively, an angular intensity distribution (with respect to the optical axis) and a transverse spatial intensity distribution.) Various effects can cause imperfect preservation of the launch angle (e.g., causing higher divergence for the output than the input rays), and multiple studies have investigated methods to minimize this effect.

GRIN fibers: Some fibers have a non-uniform RIP in the core and (less often) in the cladding. A common, non-uniform core RIP is known as “graded index” or “GRIN,” in which the index value decreases monotonically from the center of the core to the cladding. In many cases, the GRIN profile is parabolic. The size of a beam coupled into a parabolic GRIN fiber may oscillate periodically as the beam propagates along the fiber, with the oscillation period known as the “pitch” of the fiber. A parabolic GRIN fiber with an appropriate length can act as a lens that focuses or collimates a beam. This property is also used in free-space GRIN lenses, i.e., it is not limited to fibers.

Multi-clad fibers: Another example of a non-uniform RIP is a fiber with multiple claddings (“double-clad fiber,” “triple-clad fiber,” etc.). As with other non-uniform RIPs, propagation of light in a multi-clad fiber depends on the specific RIP and the launch or coupling conditions. Light launched into a given region will spread into all adjacent higher-index regions, but it may not spread into all adjacent lower-index regions (which act as a cladding for the higher-index region).

Multi-core fibers: Some fibers have multiple cores, i.e., multiple high-index guiding regions separated by surrounding low-index regions. The cores can have different sizes and shapes. A ring fiber, described above, is an example of a multi-core fiber. Light launched into a given core of a multi-core fiber will typically spread out to fill that core (as in a fiber with a single core) but will not spread into the other cores because the surrounding low-index region (cladding) prevents propagation between the cores. Multi-core fibers can be used to generate different beam shapes (i.e., near-field spatial profiles) by coupling different powers into each core. In comparison to standard fibers (especially step-index fibers), multi-core fibers have several disadvantages: (1) Multi-core fibers are generally more expensive than standard fibers. (2) The low-index regions separating the guiding regions generate highly divergent light if a portion of the beam is coupled into them. The downstream optics must be designed to accommodate this excess divergence, which typically adds cost, complexity, and/or optical loss (reduced efficiency). If not properly managed, the excess divergence can cause overheating or damage of the optics or other components. (3) The dimensions of the guiding regions are fixed when the fiber is manufactured. The beam dimensions thus cannot be continuously varied (although the power in each region can be continuously varied). Furthermore, if an application prefers different dimensions (e.g., a larger diameter ring), a new multi-core fiber must be fabricated, which can lead to a proliferation of product designs (which complicates and adds cost to manufacturing). (4) Splicing of multi-core fibers is complicated by the need to align multiple guiding regions, which each have fabrication tolerances. Achieving the desired splicing performance can require excessively tight fiber tolerances (increasing cost), low splice yields, and/or performance degradation upon splicing (e.g., from coupling light into the low-index regions, resulting in increased divergence).

Note that the above discussion of the different types of optical fibers primarily pertains to multimode fibers, in which the ray picture of light propagation is accurate. Single-mode or near-single-mode fibers introduce other phenomena that are less relevant to the embodiments described in this disclosure.

Lenses: Lenses are ubiquitous in optical systems. A lens is conventionally thought of as a piece of glass with one or both surfaces curved, and the angle of propagation of a light ray is influenced by refraction at the surfaces. Other implementations of lenses are possible, including a GRIN lens (as mentioned above) in which the RIP of the material varies with radial position (rather than employing curved surfaces). The end of a fiber or of an end cap attached to a fiber can have a curved surface to function as a lens. A design property of a lens is its focal length. A collimated input beam is focused to a point one focal length away from the lens (in the ray picture). Similarly, a point source located one focal length away from a lens is collimated at the lens output. Stated more generally, a lens maps between position and angle, i.e., a lens converts the angle of a ray at the input focal plane to position at the output focal plane, and it converts the input position of a ray at the input focal plane to angle at the output focal plane.

### Optical Beam Delivery Devices

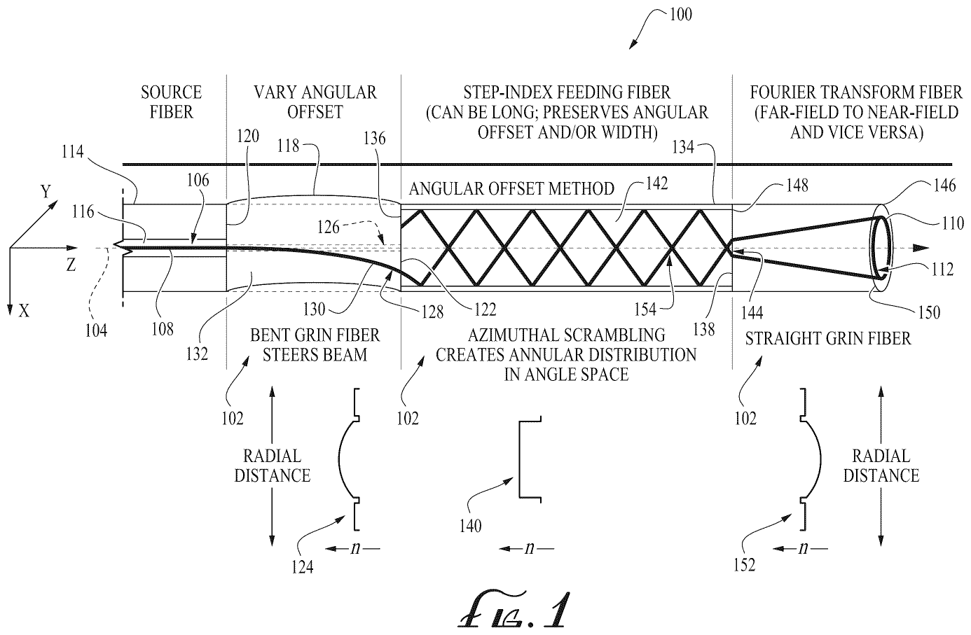

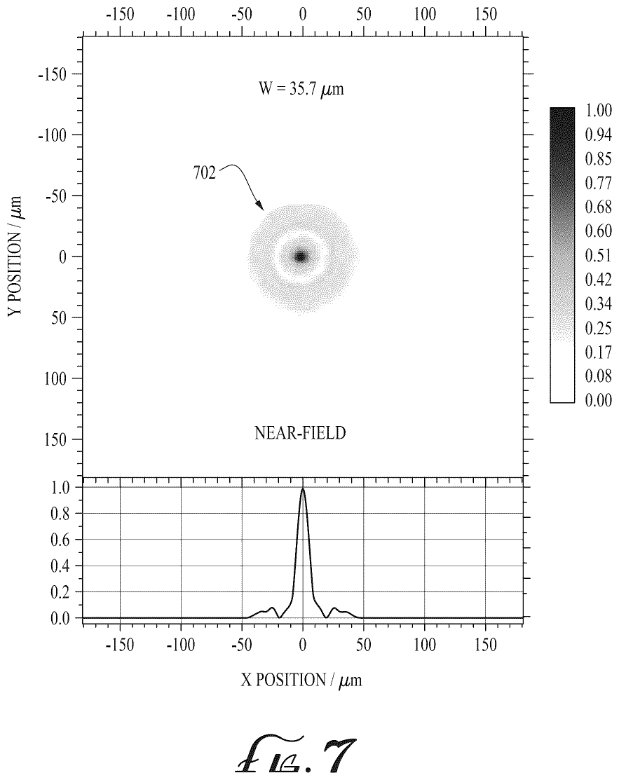

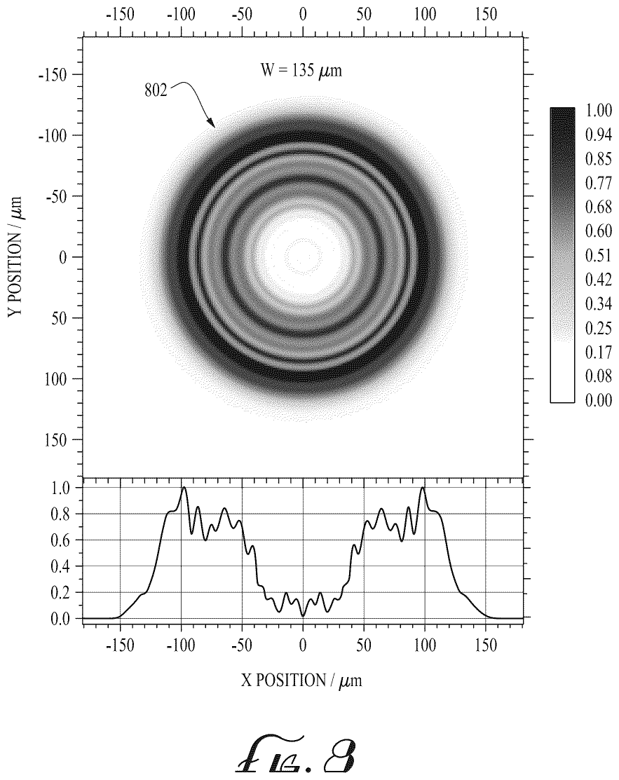

FIG. 1 shows an optical beam delivery device 100, according to a first embodiment (referred to as an angular offset embodiment). Optical beam delivery device 100 includes multiple lengths of optical fiber 102 arranged along an optical axis 104 and configured to modify an angular intensity distribution 106 of an input beam 108 so that it is converted to an output beam 110 having an adjustable near-field transverse spatial intensity distribution 112. Adjustable near-field transverse spatial intensity distribution 112 is adjustable between a centrally located spot (e.g., an approximately Gaussian or flat-top beam; see, e.g., FIG. 7) and a ring-shaped beam (see, e.g., FIG. 8).

In one embodiment of FIG. 1, input beam 108 is delivered from a source fiber 114 having a step-index core 116. In other embodiments, a source fiber is a ring fiber (e.g., one or more annular cores surrounding an optional central core), and the ring fiber may be a component of a VBC device described in the '015 patent. The term source fiber is any fiber (feeding or process) providing an input beam and that is fiber coupled (e.g., spliced) to a first length of optical fiber 118. The term fiber coupled (or couplable) includes a direct physical connection as well as connections that are slightly spaced apart, i.e., at or within one Rayleigh range, which is the distance along the propagation direction of a beam from the waist to the place where the area of the cross section is doubled.

Source fiber 114 is spliced to first length of optical fiber 118, which has a first input 120 and a first output 122. Thus, first input 120 is coupled to a source fiber 114 and is configured to receive therefrom input beam 108 that is azimuthally symmetric with respect to optical axis 104. In other embodiments, input beam 108 need not be azimuthally symmetric.

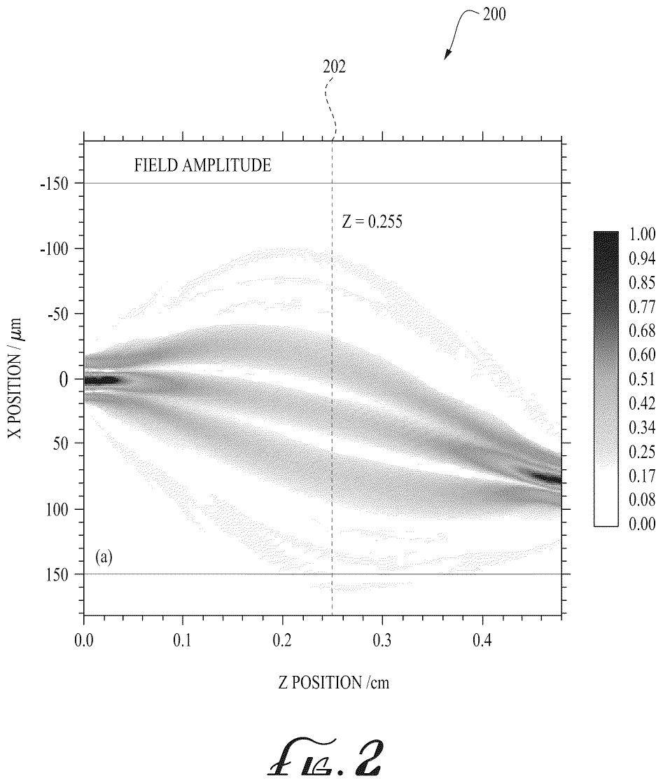

First length of optical fiber 118 has a first RIP 124. First RIP 124 is configured to produce, in response to a controllable perturbation (e.g., bending, see FIG. 2), a change in angular intensity distribution 106 from a first angular intensity distribution 126 corresponding to input beam 108 to a second angular intensity distribution 128 corresponding to a modified beam 130 at first output 122. Other examples of controllable perturbation devices are shown in FIG. 24 of the '105 patent.

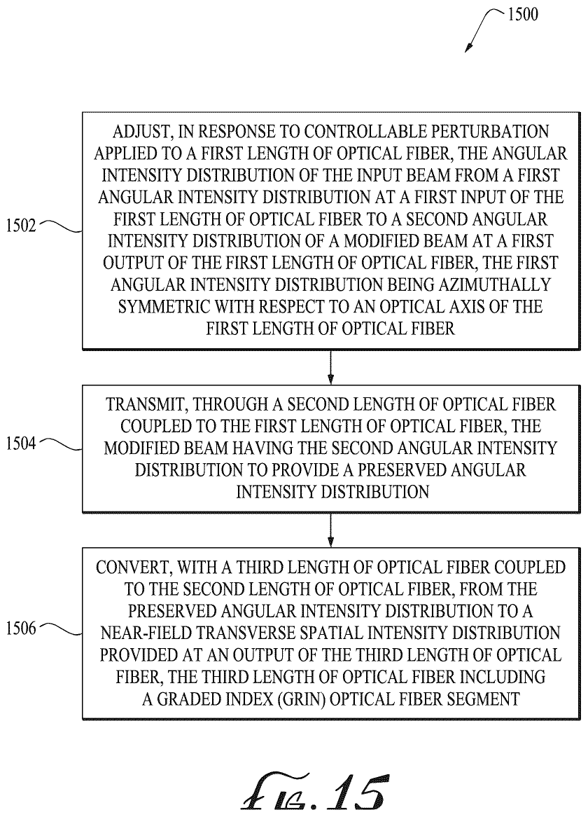

In the example of FIG. 1, first length of optical fiber 118 is a relatively short (e.g., less than 10 mm) GRIN fiber having a ¼-pitch length. At this length, input beam 108 beam reaches its maximum diameter. In other embodiments, an initial GRIN optical fiber may have a length of about ¼-pitch+N*½ pitch, where N equals zero or any positive integer. Other lengths are also possible, depending on the desired application (see e.g., FIG. 14). In a GRIN fiber, light rays transmit along sinusoidal paths. The length of fiber corresponding to one sine wave period is called the pitch, defined as follows:

$$p = \frac{2 π}{\sqrt{k}} ,$$

where k is the gradient constant determined by the refractive index profile of the GRIN fiber. The refractive index profile of the GRIN fiber is defined as set forth in W. J. Smith, Modern Optical Engineering, Third Edition, McGraw-Hill, Inc. (2000), p. 286:

$$n ( r ) = {n}_{0} ( 1 - ( \frac{k}{2} ) {r}^{2} ) ,$$

where n₀ is the axial refractive index of the GRIN fiber.

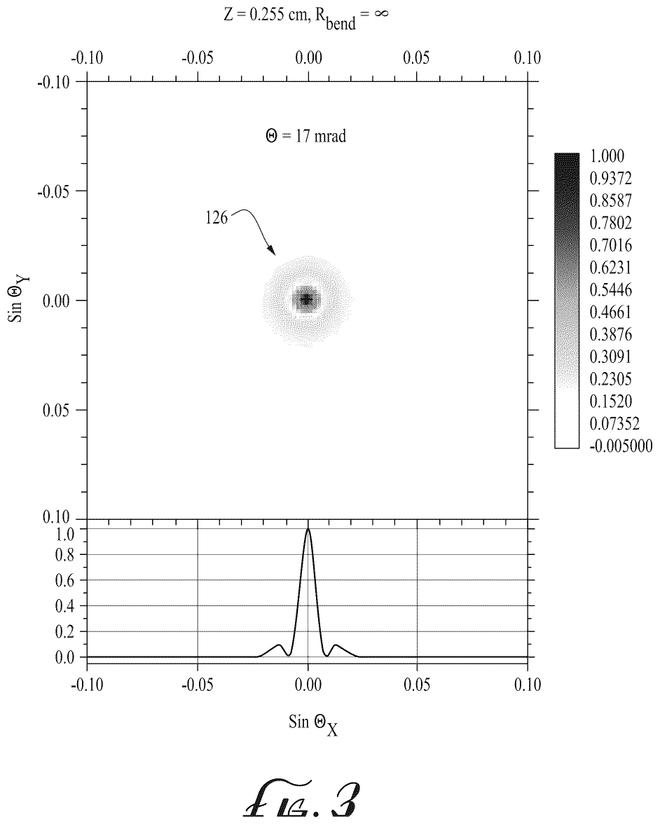

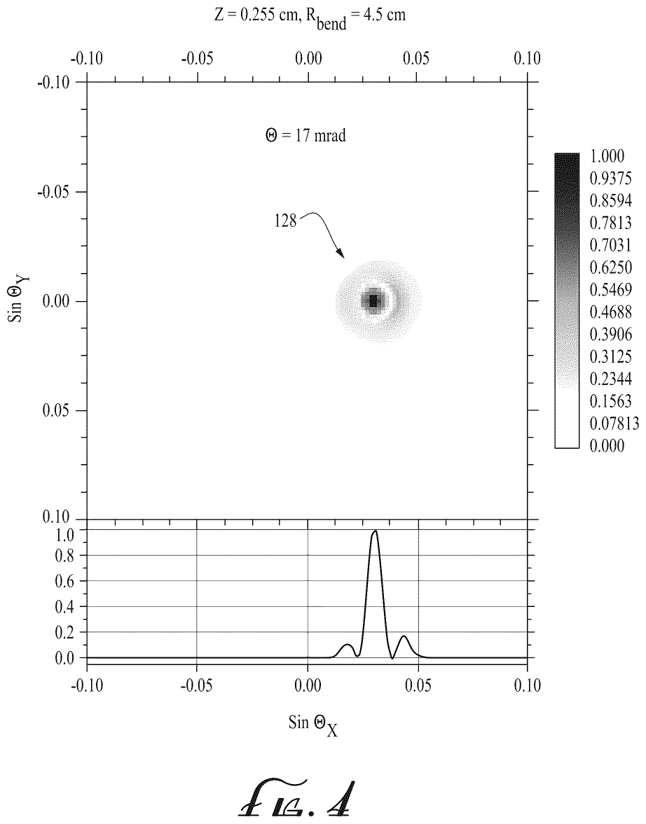

In some embodiments, first length of optical fiber 118 and an initial section of a second length of optical fiber 134 are bent a variable amount (or not at all) around a mandrel (not shown) or other device shown and described in FIG. 24 of the '015 patent. Angular intensity distribution 106 of input beam 108 beam is thereby varied by changing its angular offset without necessarily affecting its width. For instance, first angular intensity distribution 126 has negligible angular offset with respect to optical axis 104 (see, e.g., FIG. 3) when first length of optical fiber 118 is not perturbed (i.e., straight, as indicated by dashed lines on first length of optical fiber 118) whereas second angular intensity distribution 128 includes a relatively large angular offset (see, e.g., FIG. 4) when first length of optical fiber 118 is perturbed (e.g., bent, as indicated in FIG. 1).

Second length of optical fiber 134, which includes a second input 136 and a second output 138, is coupled to first output 122 and configured to receive therefrom modified beam 130. Second length of optical fiber 134 has a step-index RIP 140 configured to preserve second angular intensity distribution 128. Modified beam 130 enters a divergence-preserving fiber 142 (e.g., core diameter of 300 μm) and propagates while substantially preserving the angular offset with respect to optical axis 104. Second angular intensity distribution 128 is preserved, i.e., its ray angles relative to optical axis 104 (i.e., the fiber core) remain substantially constant from second input 136 to second output 138. Although it is largely preserved, for purposes of clarity (and recognizing that there may be some minor variation in the distributions) this disclosure refers to second angular intensity distribution 128 at second output 138 as a preserved angular intensity distribution 144.

In some embodiments, second length of optical fiber 134 may be about five meters to about 50 meters long so as to transport modified beam 130 a significant distance from the source (e.g., to a processing head or tool). As modified beam 130 travels through second length of optical fiber 134, second angular intensity distribution 128 is azimuthally averaged (i.e., azimuthally smoothed or symmetrized) due to normal routing (coiling or bending) of this delivery fiber. Thus, phi ray angles (azimuthal) are assumed to be scrambled in second length of optical fiber 134. The angular width of input beam 108 results from rays having slightly different angles. These rays take different paths (generally helical) and end up being scrambled azimuthally (cylindrically symmetric, phi invariant), although for simplicity FIG. 1 shows only two paths.

Finally, FIG. 1 shows optical beam delivery device 100 with a third length of optical fiber 146, e.g., a GRIN fiber. Third length of optical fiber 146 includes a third input 148 and a third output 150. Third input 148 is coupled to second output 138 and is configured to receive therefrom modified beam 130 having preserved angular intensity distribution 144. Third length of optical fiber 146 has a GRIN RIP 152 which generates, at third output 150, output beam 110 having adjustable near-field transverse spatial intensity distribution 112 corresponding to preserved angular intensity distribution 144 of modified beam 130. In some embodiments, output beam 110 at third output 150 is ring shaped. The diameter of the ring may be determined by the input angular offset and the thickness of the ring by the input divergence width.

FIG. 2 shows a simulated implementation of the angular offset technique shown and described previously with reference to FIG. 1. For instance, FIG. 2 shows, in an X-Z plane, an LP₀₂ mode field 200 of input beam 108 as it propagates through first length of optical fiber 118 along the Z-axis direction from first input 120. LP₀₂ mode field 200 is shown as first length of optical fiber 118 is subjected to a decreasing bend radius. “Field amplitude” refers to the light distribution, which is showing the field amplitude |E| as opposed to field intensity |E|².

The bottom axis of FIG. 2 shows that propagation is simulated through a distance of a ½ GRIN pitch length, with a ¼ GRIN pitch length 202 (Z=0.255 cm) indicated by a vertical dashed line. As described previously, first length of optical fiber 118 could be cut and spliced to second input 136 of second length of optical fiber 134 at ¼ GRIN pitch length 202 or other desired lengths.

Through simulations, GRIN pitch, fiber length, and bending profile may be tailored to achieve a desired angular offset of input beam 108 with a minimal change in divergence. For example, to maximize angular offset without increasing divergence, a specific length of GRIN fiber could be used as the first length of optical fiber and subjected to bending to create a desired angular offset. The pitch of the GRIN may be selected to increase the beam diameter, thus lowering its divergence width and maximizing the ratio between angular offset and width. Specifically, for a given input beam divergence and spot size, a focal length of a ¼-pitch GRIN fiber may be chosen to decrease the divergence of the beam exiting the GRIN fiber.

FIG. 3 and FIG. 4 provide a simulated comparison at 0.255 cm (¼ pitch length) between first angular intensity distribution 126 and second angular intensity distribution 128 shown, respectively, without bending and with bending of first length of optical fiber 118. Specifically, FIG. 4 shows that with bending, second angular intensity distribution 128 is transversely shifted in the bend plane by about 30 mrad, which is much greater than the divergence width of about 17 mrad. In these figures, the top frame is a two-dimensional (X, Y=0) image of the beam, and the lower frame is a one-dimensional (X) cut through the beam.

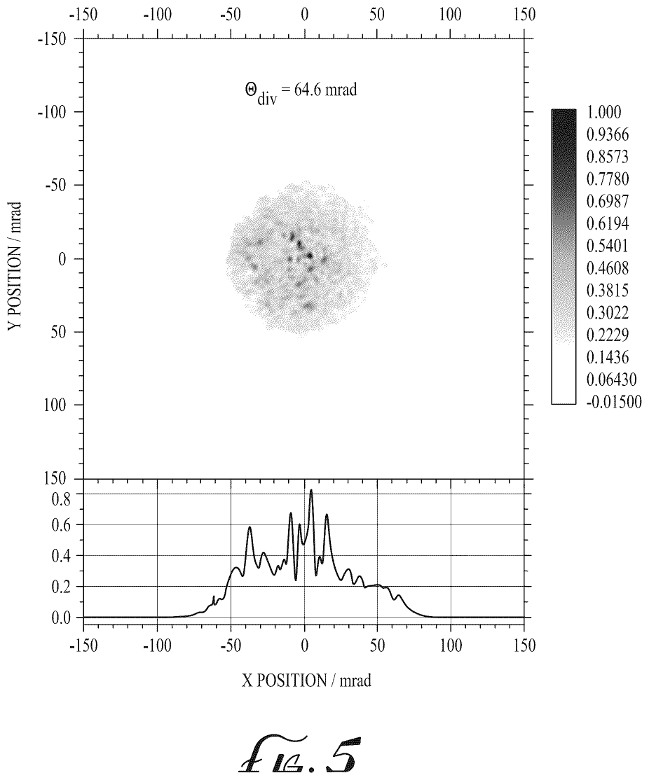

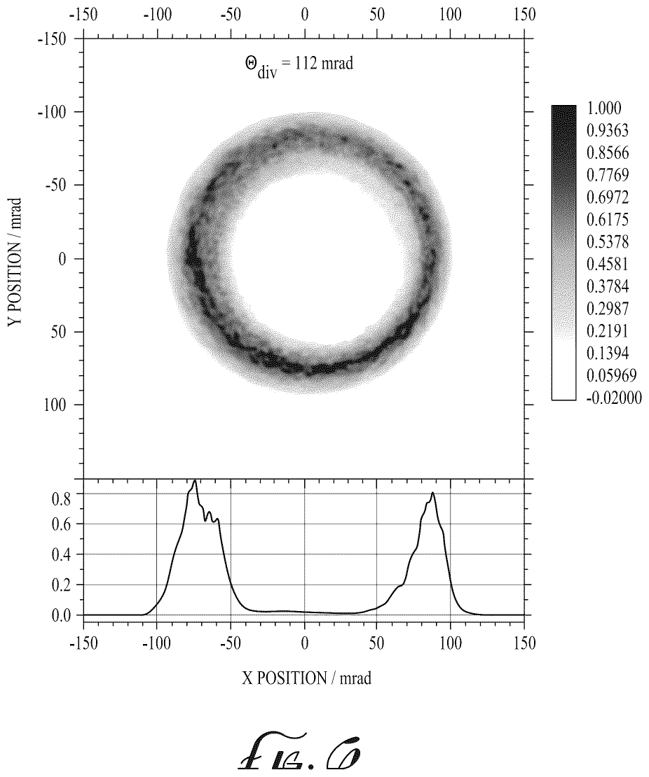

FIG. 5 and FIG. 6 show results of an experiment employing a GRIN fiber having a larger pitch than the one used in the aforementioned simulations. Spliced onto the GRIN fiber is a divergence-preserving fiber. These measurements show the intensity distributions downstream from the divergence-preserving fiber (i.e., when the beams emerging from the divergence-preserving fiber are projected onto a screen), corresponding to the divergence distributions within the divergence-preserving fiber. In these figures, the top frame is a two-dimensional (X) image of the beam, and the lower frame is a one-dimensional (X, Y=0) cut through the beam. The intensity (divergence) distribution shown in FIG. 5 is formed without bending of GRIN fiber 118.

In contrast, FIG. 6 shows that a larger (i.e., more divergent), ring-shaped beam is formed when GRIN fiber 118 is bent. These divergence distributions could be converted to near-field images at third output 150 of second GRIN fiber 146 by splicing that second GRIN fiber 146 to divergence-preserving fiber 134, as shown in FIG. 1. The magnification imparted to the output beam is selectable by choice of the effective focal length (i.e., gradient constant) of second GRIN fiber 146. For example, an input GRIN having a gradient constant of 2.0 and output GRIN having a gradient constant of 0.5 results in an approximately 2× magnification of the near field beam diameter. Likewise, an input GRIN having a gradient constant of 0.5 and output GRIN having a gradient constant of 2.0 results in an approximately 0.5× magnification of the near-field beam diameter. Gradient constants ranging between 0.1 and 50 are also possible, depending on the application.

FIG. 6 also shows second angular intensity (divergence) distribution 128 is circularized by propagation in second length of optical fiber 134, but the angle with respect to the Z axis is preserved.

FIG. 7 and FIG. 8 show simulations of output beam 110 near-field spatial profile at third output 150 of third length of optical fiber 146, respectively, without and with bending applied to first length of optical fiber 118. In these figures, the top frame is a two-dimensional (X, Y) image of the beam, and the lower frame is a one-dimensional (X, Y=0) cut through the beam.

In FIG. 7, the output and input beam shapes and sizes are similar, i.e., there is no significant near-field adjustment when converting from first angular intensity distribution 126 to a near-field transverse spatial intensity distribution 702 corresponding to output beam 110 having a relatively small beam diameter.

In contrast, FIG. 8 shows a significant change between the near-field spatial profiles of the input and output beams, with output beam 110 having a ring shape. Accordingly, near-field transverse spatial intensity distribution 702 and near-field transverse spatial intensity distribution 802 show an example of adjustable near-field transverse spatial intensity distribution 112.

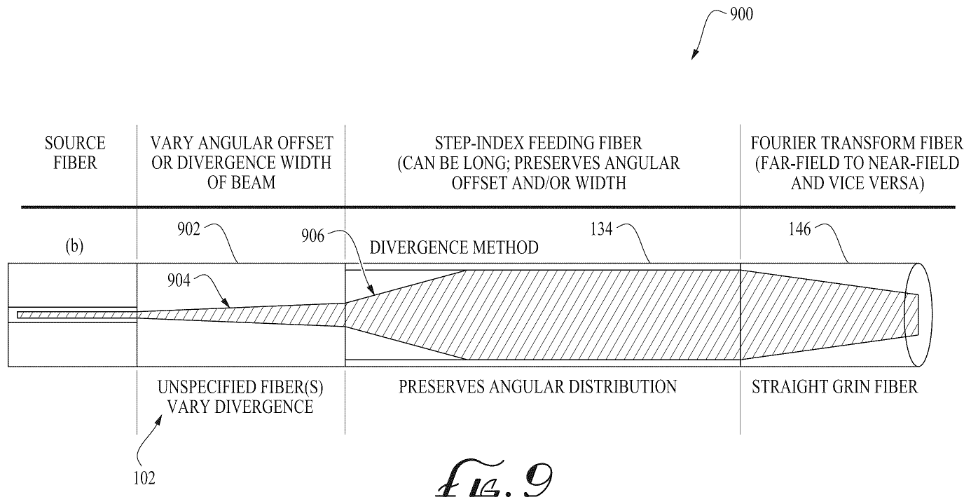

FIG. 9 shows an optical beam delivery device 900, according a second embodiment (referred to as an angular width/divergence embodiment). Like optical beam delivery device 100, optical beam delivery device 900 includes multiple lengths of optical fiber 102 to convert changes in angular intensity distribution to changes in near-field transverse spatial intensity distribution. Instead of having first length of optical fiber 118 configured to change the angular offset of input beam 108, optical beam delivery device 900 includes a first length of optical fiber 902 that is configured to change a width of an angular intensity distribution 904 in response to a controllable perturbation. As described previously, a modified beam 906 enters second length of optical fiber 134 (a divergence-preserving fiber) and propagates while preserving the angular distribution. Third length of optical fiber 146 in the form of a GRIN fiber at the output images modified beam 906 beam into a variable-diameter beam appearing at the output facet of the GRIN fiber.

Note that the GRIN design pitch can be selected to size the output near-field diameters and divergences. Through simulations, GRIN pitch, fiber length, and bending profile may be tailored to achieve a desired output.

Skilled persons will appreciate that various techniques and fibers may be used to increase divergence in response to perturbation of first length of optical fiber 902. For example, first length of optical fiber 902 may be a step-index fiber configured to respond to a non-adiabatic micro-bend (see, e.g., FIG. 12).

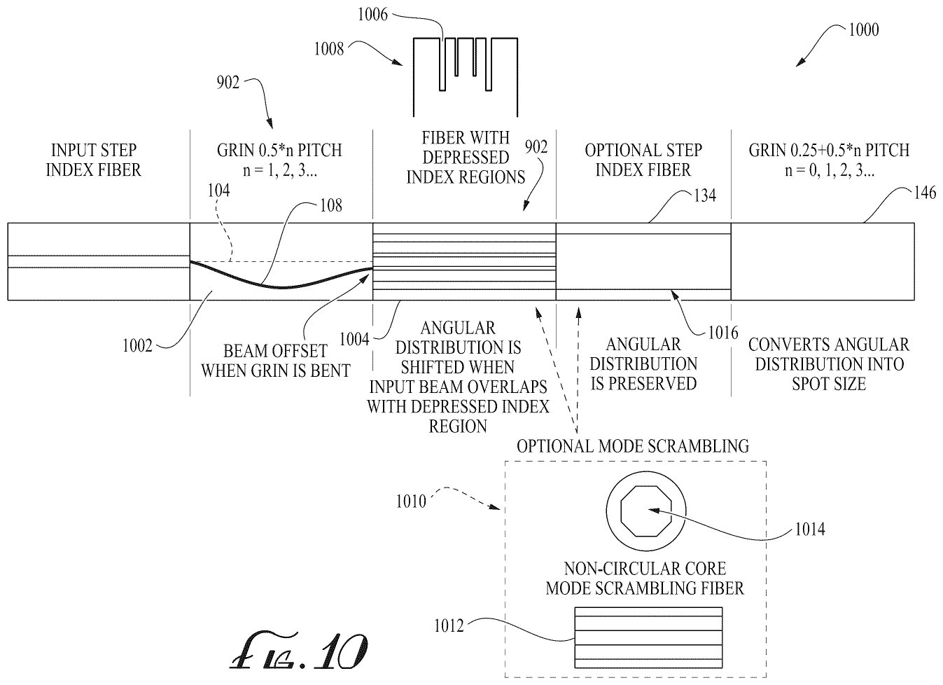

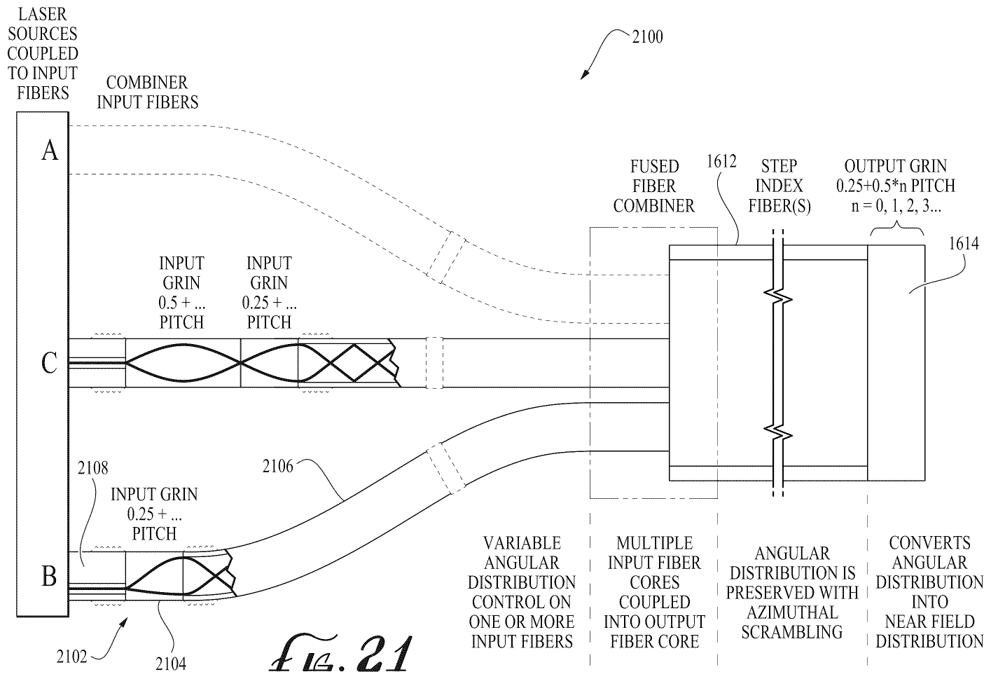

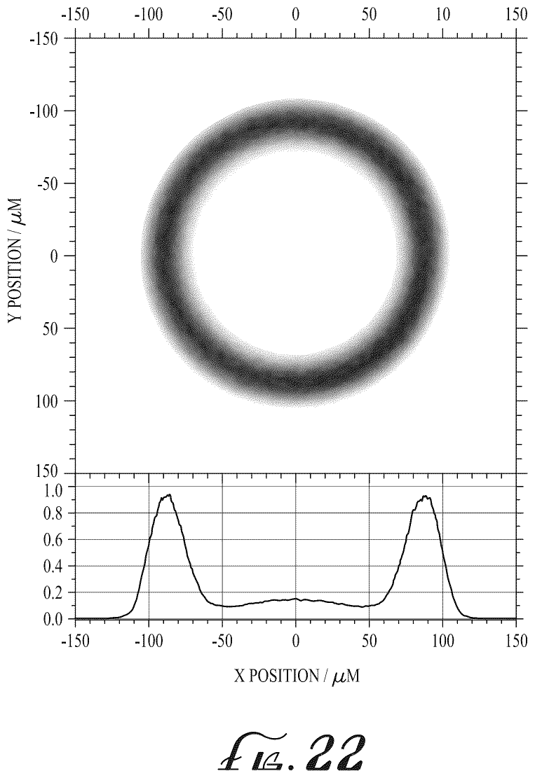

In another embodiment, FIG. 10 shows an optical beam delivery device 1000 in which first length of optical fiber 902 includes a first portion 1002 and a second portion 1004 coupled to first portion 1002. First portion 1002 includes a GRIN optical fiber having a length of about N*½ pitch, where N equals any positive integer. Other lengths are also possible, depending on the design, but the length of about N*½ pitch facilitates interaction of the beam with low-index divergence structures 1006 in second portion 1004. Divergence structures 1006 (shown in RIP 1008) are designed to increase divergence. When first portion 1002 is perturbed, input beam 108 is displaced from optical axis 104 so that it is incident upon at least one of divergence structures 1006, which increases divergence to provide a modified beam to second length of optical fiber 134. Other examples of divergence structures are shown in FIG. 20 and FIG. 21 of the '015 patent (see, e.g., RIP 2102 in the '015 patent).

FIG. 10 also shows an example of an optional mode-scrambling portion 1010. For instance, a divergence-preserving fiber 1012 having a non-circular core 1014 may be coupled between an output of first length of optical fiber 902 and an input of second length of optical fiber 134. In some embodiments, divergence-preserving fiber 1012 itself acts as second length of optical fiber 134 (e.g., where a non-circular aperture is acceptable). When a circular aperture is desired, then a circular core divergence-preserving fiber 1016 is included. Circular core divergence-preserving fiber 1016 has about the same core diameter as that of non-circular core 1014 (or a slightly larger diameter) to ensure there is minimal loss of light from the core to the cladding at the splice.

Non-circular core 1014 is shown as having an octagonal shaped core. In other embodiments, a mode scrambling fiber could have a core that is rectangular, hexagonal, D-shaped, or another non-circular shape capable of homogenizing the mode distribution in the fiber. The length of divergence-preserving fiber 1012 would typically be approximately 0.1-2 m without a cladding light stripper (CLS) and approximately 2-5 m with a CLS, although other lengths are possible.

Skilled persons will appreciate that mode-scrambling portion 1010 may be included in any of the embodiments described in this disclosure. Using mode-scrambling portion 1010 (i.e., for changing the spatial distribution of an intermediate beam in the fiber assemblies) influences the far-field divergence profile (i.e., by homogenizing divergence distribution) while not changing the near-field beam shape at the output of the device. In other words, a near-field ring profile at the output is generated according to the divergence distribution of the intermediate beam, which need not be substantially modified by mode-scrambling portion 1010. But the presence of mode-scrambling portion 1010 in the divergence-preserving fiber may have a desirable influence on the far-field divergence profile for certain applications.

A flat-top beam is one having low beam uniformity (0 for an ideal flat-top) and high flatness factor (1 for an ideal flat-top) as defined by ISO 13694:2005. For some laser processing applications, a flat-top divergence distribution corresponds to a beam uniformity of less than or equal to 0.2 and a flatness factor of greater than 0.5. Note that other metrics or specifications may be used to define the flat-top beam shape, depending on the needs of the application.

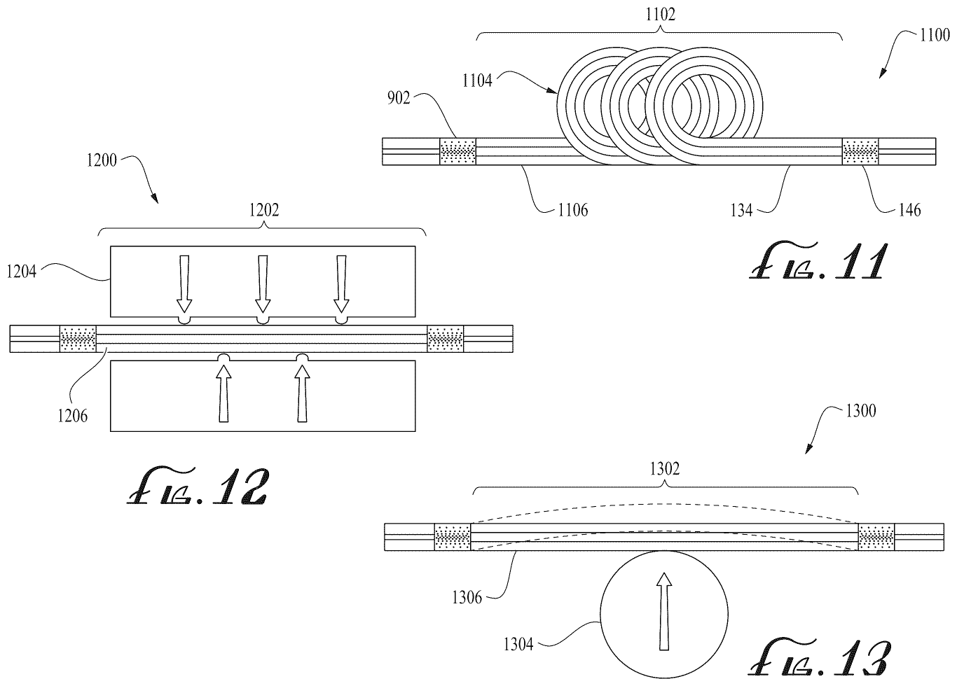

FIG. 11-FIG. 13 show other example embodiments for achieving the desired mode scrambling (e.g., without the use of non-circular core fiber). For instance, FIG. 11 shows an optical beam delivery device 1100 having a divergence-preserving fiber section 1102 that includes one or more coils 1104 in a diverge-preserving fiber 1106 for imparting mode scrambling, but it is otherwise functionally similar to mode-scrambling portion 1010 (FIG. 10). In some embodiments, the one or more coils are established by wrapping diverge-preserving fiber 1106 around a fixture.

In another example, FIG. 12 shows an optical beam delivery device 1200 having a divergence-preserving fiber section 1202 in which a micro-bend device 1204 is used for micro-bending a diverge-preserving fiber 1206 so as to impart mode scrambling in the intermediate beam guided by diverge-preserving fiber 1206. Otherwise, divergence-preserving fiber section 1202 is functionally similar to mode-scrambling portion 1010 (FIG. 10). In some embodiments, micro-bend device 1204 includes one or more structures that perturb the fiber.

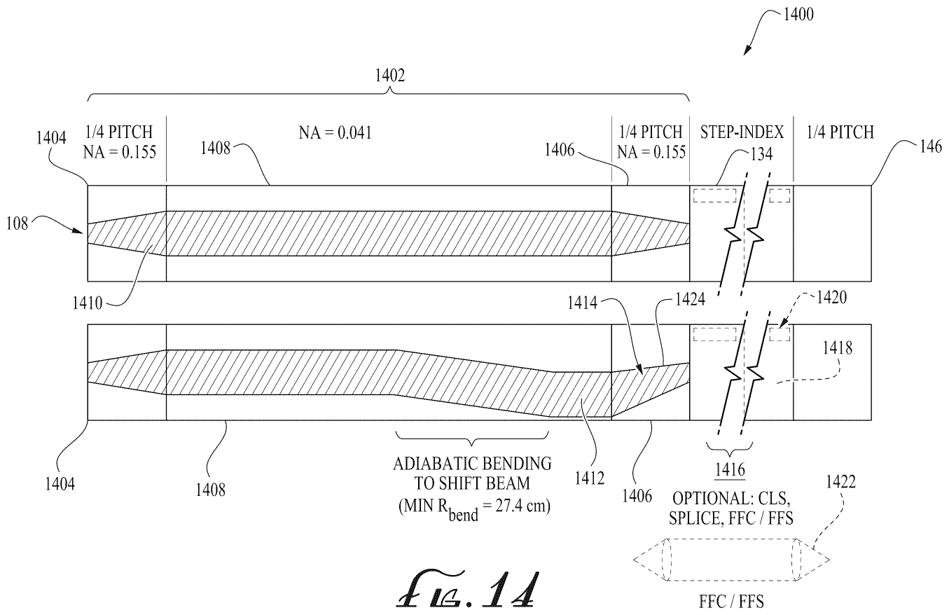

In another example, FIG. 13 shows an optical beam delivery device 1300 having a divergence-preserving fiber section 1302 in which a mandrel 1304 (or other perturbation device) is used for macro-bending a diverge-preserving fiber 1306 so as to impart mode scrambling in the intermediate beam guided by diverge-preserving fiber 1306. Otherwise, divergence-preserving fiber section 1302 is functionally similar to mode-scrambling portion 1010 (FIG. 10). In some embodiments, mandrel 1304 includes one or more structures that perturb the fiber, e.g., to create one or more macro-bends that may have the same or different bend radii.

Skilled persons will appreciate that other mode-distribution homogenization techniques may also be employed. For instance, an offset splice may also be used to join step index source fiber 114 to first length of optical fiber 902. This type of splice would excite higher-order or a larger number of modes.

FIG. 14 shows another embodiment of an optical beam delivery device 1400, which includes a first length of fiber 1402 having an input GRIN portion 1404, an output GRIN portion 1406, and a central GRIN portion 1408 therebetween. Input GRIN portion 1404 is configured to collimate input beam 108 to provide a collimated beam 1410. Central GRIN portion 1408 is configured to shift collimated beam 1410 in response to controllable perturbation (e.g., bending, as shown in bottom diagram of FIG. 14) so as to provide a shifted beam 1412. Output GRIN portion 1406 is configured to focus shifted beam 1412 to provide modified beam 130 having an angular offset 1414 that is different from that of input beam 108.

Skilled persons will appreciate in light of this disclosure that both optical beam delivery device 1400 and optical beam delivery device 100 (FIG. 1) act to vary an angular offset that is delivered second length of optical fiber 134. Furthermore, optical beam delivery device 1400 may be modified to also vary divergence. For instance, by employing different NAs for input GRIN portion 1404 and output GRIN portion 1406, the angular width (divergence angle) may also be tuned. Input GRIN portion 1404 and output GRIN portion 1406 are each shown as having ¼-pitch length, but other lengths are also possible. The effective focal length of these portions may be designed to provide different divergences of modified beam 130 or to change other beam properties to accommodate the desired use case. In contrast to ¼- or ½-pitch lengths described previously for first length of optical fiber 118 (FIG. 1), optical beam delivery device 1400 also provides an example of how first length of fiber 1402 may have varied lengths for different applications.

FIG. 14 also shows an example of optional features 1416, such as an optional splice 1418, optional CLS 1420, and an optional fiber-to-fiber coupler/fiber-to-fiber switch (FFC/FFS) 1422. As explained in the following paragraphs, any of optional features 1416 may be included in second length of optical fiber 134. These optional features may be applied to any of the other embodiments described in this disclosure.

Including optional splice 1418 in second length of optical fiber 134 is advantageous for manufacturing and for field service. For instance, it is common to build up subassemblies that are spliced together to form optical beam delivery device (e.g., optical beam delivery device 1400). Including optional splice 1418 in the fiber allows different output beam parameters to be generated by choosing a different output “pigtail” (i.e., a replacement portion of second length of optical fiber 134 and third length of optical fiber 146). As explained in more detail below, an effective focal length of third length of optical fiber 146 maybe be changed using a different replacement subassembly or subassemblies. In another example, core or cladding diameter sizes may be stepped up or stepped down. A large number of possible combinations is enabled with a minimal number of subassemblies.

Optional splice 1418 also enables relatively inexpensive rework and minimizes yield loss. For example, if the pigtail is damaged, only the pigtail has to be replaced, rather than replacing an entire fiber assembly. Similarly, including optional splice 1418 is also advantageous for service (in the field or at a depot). It is relatively common to burn the face of the end cap on the feeding fiber. The cost and complexity of the part that has to be replaced is minimized by including optional splice 1418, such that the field-replaceable unit (FRU) is the pigtail. Furthermore, if a customer or end-user wanted to change the configuration of their laser (different spot size, divergence, or both), then the FRU could be changed at the customer or end-user site relatively easily and inexpensively.

In addition, optional splice 1418 facilitates stepping up or down the core diameter, which enables accommodation of splicing and fiber tolerances to simplify the splicing process and increase the yield. A step up means a core diameter of second length of optical fiber 134 after the splice is larger than that of second length of optical fiber 134 before the splice. Likewise, a step down means a core diameter of second length of optical fiber 134 is smaller after the splice than it is before the splice. The fiber core diameter can have some variation between batches and within a batch. If this variation causes a step down at the splice, there may be optical loss or divergence increase (from coupling of light from the core into the cladding at the splice). Similarly, splicers have alignment tolerances that can cause imperfect alignment of the fiber cores at the splice, which can again result in optical loss or divergence increase. Including a step up in the core diameter at optional splice 1418 minimizes or eliminates these problems, ensuring that the splice has a high yield and minimizing degradation of the optical performance or reliability from the splice. For example, a step up of about 2-10 μm is typical for some applications, but a larger step up is possible and may be desirable (depending on the desired output beam characteristics).

In another embodiment, the cladding diameter may be stepped up or down at optional splice 1418, in addition to or separate from any change in the core diameter. A step up means an outside cladding diameter of second length of optical fiber 134 is larger after the splice than it is before the splice. Likewise, a step down means an outside cladding diameter of second length of optical fiber 134 is smaller than it is before the splice. The inside diameters would depend on core sizes, which as explained above, may also be adjusted at optional splice 1418. For instance, a step down of the cladding could be desirable for reliability because it ensures that back-reflected light (e.g., from the workpiece) remains in the cladding and is not lost at optional splice 1418 or coupled into the polymer (i.e., fiber buffer or potting around optional splice 1418, not shown), which can cause damage.

In some embodiments, light launched into cladding of divergence-preserving second length of optical fiber 134 is removed by optional CLS 1420. This approach allows for removal of high-NA light in the optical beam delivery device rather than in downstream optics (e.g., a process head, collimator, or scanner). In some embodiments, optional CLS 1420 is included at input of second length of optical fiber 134. Another option is to include optional CLS 1420 at an output of a laser source (not shown) providing input beam 108. And yet another option is to include optional CLS 1420 on one or both sides of optional splice 1418. The various CLS options may be combined, depending on the possible presence of cladding light at different locations.

Optional FFC/FFS 1422 may be positioned along second length of optical fiber 134 (e.g., two step-index fibers separated by the coupler or switch). The two fibers ends on either side of optional FFC/FFS 1422 may have the same or different core and cladding diameters. The output characteristics of the beam delivered in this configuration may be controlled by selection of the FRU (i.e., by the design of the fiber assembly downstream of the FFC/FFS, specifically the core diameter of the divergence-preserving fiber and the focal length of the GRIN lens). The embodiment with the FFC/FFS enables delivery of a structured beam without the need to image this beam shape onto the process fiber input and without requiring a multi-core process fiber, which offers significant advantages for fiber fabrication tolerances, beam alignment tolerances, and performance of the free-space optics in the FFC/FFS and for preventing generation of a high-NA tail in the output beam from the process fiber. Furthermore, the fiber assembly comprising the process fiber can include a splice that steps up or down the core and/or cladding diameters, which has some of the advantages discussed above in the context of a splice in the feeding fiber.

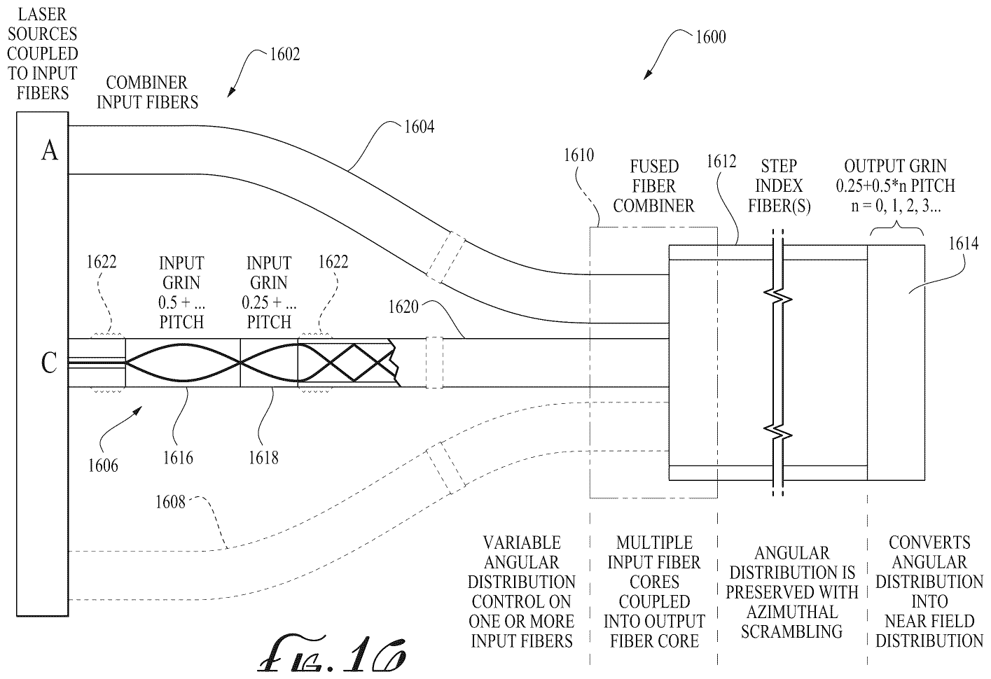

FIG. 15 shows a method 1500 of modifying an angular intensity distribution of an input beam so that it is converted to an output beam having an adjustable near-field transverse spatial intensity distribution.

In block 1502, method 1500 adjusts, in response to controllable perturbation applied to a first length of optical fiber, the angular intensity distribution of the input beam from a first angular intensity distribution at a first input of the first length of optical fiber to a second angular intensity distribution of a modified beam at a first output of the first length of optical fiber, the first angular intensity distribution being azimuthally symmetric with respect to an optical axis of the first length of optical fiber. In other embodiments, the distribution need not be azimuthally symmetric.

In block 1504, method 1500 transmits, through a second length of optical fiber coupled to the first length of optical fiber, the modified beam having the second angular intensity distribution. In some cases, the second length of optical fiber largely preserves the second angular intensity distribution as the beam propagates through the fiber.

In block 1506, method 1500 converts, with a third length of optical fiber coupled to the second length of optical fiber, from the second angular intensity distribution to a near-field transverse spatial intensity distribution provided at an output of the third length of optical fiber, the third length of optical fiber including a GRIN optical fiber.

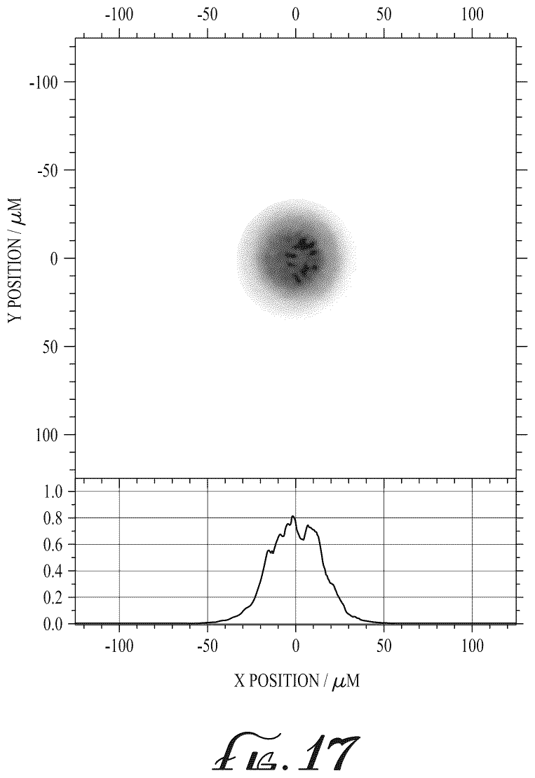

FIG. 16 shows another embodiment of an optical beam delivery system 1600 for generating composite beam shapes using separately controllable laser sources (not shown), each one of which is coupled to a different input fiber 1602. In this example, a first laser source is coupled to a first input fiber 1604, a second laser source is coupled to a second input fiber 1606, a third laser source is coupled to a third input fiber 1608. In some embodiments, there may be different numbers (or different types) of input fibers.

A fused fiber combiner 1610 couples each input fiber 1604, 1606, and 1608 to a divergence-preserving fiber 1612 (also called an angular- or divergence-distribution preserving fiber), which is coupled to an output GRIN fiber 1614. As described previously, divergence-preserving fiber 1612 is a step-index fiber and output GRIN fiber 1614 acts as a lens, i.e., having a pitch of ¼+½*N, where N equals zero or any positive integer (0, 1, 2, . . . ). Other types of lenses are also possible, e.g., ball lenses, radiused end caps, or free-space optics.

In the example of FIG. 16, first input fiber 1604 is a step-index fiber. Accordingly, in conjunction with divergence-preserving fiber 1612 and output GRIN fiber 1614, an output beam (previously guided by first input fiber 1604) is centrally located (i.e., coaxial with the axis of fiber 1612) with a near-field diameter proportional to the source laser divergence.

Second input fiber 1606 is a fiber assembly that, when coupled with divergence-preserving fiber 1612 and output GRIN fiber 1614, is functionally similar to optical beam delivery device 100, optical beam delivery device 900, optical beam delivery device 1400, and the like. Specifically, a bend-sensitive GRIN fiber 1616 (see, e.g., input GRIN portion 1404 and central GRIN portion 1408, FIG. 14) is coupled to a GRIN lens 1618 (see, e.g., output GRIN portion 1406, FIG. 14). In this example, bend-sensitive GRIN fiber 1616 has a length of about N*½ pitch, where N is any positive integer (see, e.g., GRIN fiber 1002, FIG. 10). Next, GRIN lens 1618 has a length of about ¼+N*½ pitch, where N equals zero or any positive integer. This length of GRIN fiber converts a near-field transverse spatial intensity distribution to a divergence distribution. In other words, GRIN lens 1618 maps from position to angle, with position being adjustable by perturbing bend-sensitive GRIN fiber 1616 such that the divergence-distribution varies in response at an output of GRIN lens 1618. Next, a divergence-preserving fiber 1620 guides the intermediate beam it receives while preserving its divergence distribution. Likewise, divergence-preserving fiber 1612 guides the distribution to output GRIN fiber 1614, which converts back from angle to position. Thus, the beam shape contributed by this fiber is variable from a central Gaussian-like beam to a ring beam.

When multiple lasers sources are coupled into combiner input channels simultaneously—each of which may be separately controllable in terms of power level, power modulation (e.g., pulsing), or more generally the output waveform (power vs. time)—the combined output beam near-field spatial profile is a superposition of the individual channel output beams. This approach allows the combined power of the multiple input sources to be superimposed within the same near-field beam profile, independently selected to different intermediate spatial profiles between a spot and a ring, and superimposed within the same near-field beam profile by the system controller. Since the size of ring, saddle, or pedestal shapes is selectable based on radial offset of the input source(s), different combinations of nested or overlapping ring, saddle, or pedestal shapes are also possible.

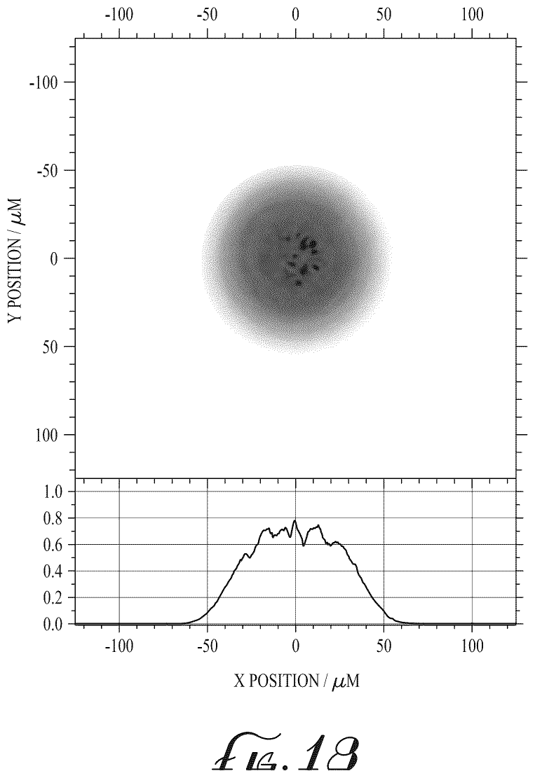

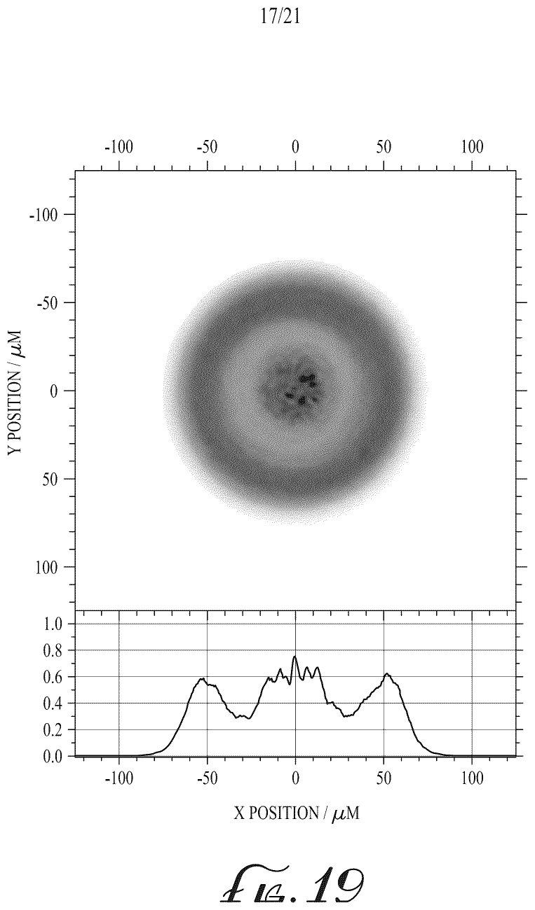

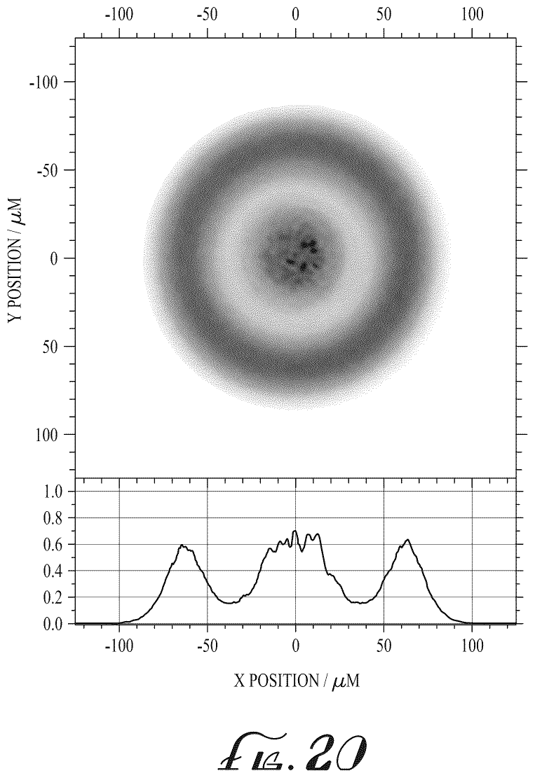

Because sources of beams for each input fiber of optical beam delivery system 1600 are separately controllable, different fibers and combinations of fibers may propagate beams that are combined to generate composite beam shapes at the output of output GRIN fiber 1614. For example, FIG. 17-FIG. 20 show outputs from output GRIN fiber 1614 as first input fiber 1604 and second input fiber 1606 providing beams, and as increasing perturbation is applied to bend-sensitive GRIN fiber 1616 (e.g., FIG. 17 showing no perturbation and FIG. 20 shown the most perturbation).

Different input fibers or combinations of input fibers can be temporally modulated (e.g., rapidly switched to apply power at different times to different input fibers) such that, with respect to the workpiece, the delivered beam over time is an average of the different inputs. The switching between each output beam shape may occur at frequencies from single Hz or lower to multiple MHz or higher. In general, any temporal waveform can be applied to any of the input beams.

Many laser cutting, welding, and additive manufacturing applications, such as those using two- or three-axis scanners, require the laser beam to have sufficiently low divergence to avoid overheating and damage to the process optics. As a result, optical beam delivery system 1600 can be optimized to produce low divergence and with second-moment beam diameters sizes ranging from about 50 to about 600 μm, although other sizes are possible. By varying the power in the central beam and the power in the ring beam independently, properties of a weld such as the welding mode (conduction versus keyhole), weld depth or profile, and features related to the weld melt pool dynamics (smoke, spatter, porosity, process stability) can be optimized for a given application.

In the proposed approach, the angular offset of an input beam could be controlled to enable modulation of the divergence in one or more input fibers. The divergence of the input beam(s) can optionally be modulated at a frequency on the order of 1 Hz to 10 kHz (for example) during material processing. Accordingly, the output ring diameter is actively modulated during a welding process (or other process) based on the frequency of the perturbation applied to the variable beam channel.

Skilled persons will appreciate that the input and output GRIN lenses may have different effective focal lengths, for magnification or demagnification. For instance, output GRIN fiber 1614 can have a larger or smaller 0.25 pitch effective focal length with respect the input 0.25 pitch GRIN(s) to provide magnification or demagnification of the beam. Other design optimizations described previously may be implemented, such as, for example, inclusion of optional step-up or step-down splices for the core and/or the cladding, an FFC/FFS, and/or various CLSs. In the present example, CLSs 1622 are shown at an input step-index fiber and at the input of divergence-preserving fiber 1620. Further customization of the system is possible including any of the following. An optional CLS may be added to step index fiber 1612 on combiner 1610 output. A splice to divergence-preserving fiber 1612 with the same or larger diameter before output GRIN fiber 1614 can be added. An FFC/FFS may be employed between fused fiber combiner 1610 output step index fiber and a step index delivery fiber containing output GRIN fiber 1614.

FIG. 21 shows another variant of an optical beam delivery system 2100, which is similar to optical beam delivery system 1600 except third input fiber 1608 is shown as a fiber assembly 2102. The details of fiber assembly 2102 and its capability for generating structured beams is explained in another patent application by nLIGHT, Inc., titled “FIBER ASSEMBLIES FOR RING OR COMPOSITE BEAM OUTPUT” (Attorney Docket No. 67314/3202). As explained in that other application, fiber assembly 2102 includes a first lens 2104 (e.g., a ¼ pitch GRIN lens) to convert a transverse spatial intensity distribution to a divergence distribution. The divergence distribution is the preserved by a divergence-preserving fiber 2106 and divergence-preserving fiber 1612. Output GRIN fiber 1614 then converts the divergence distribution to an output transverse spatial intensity distribution.

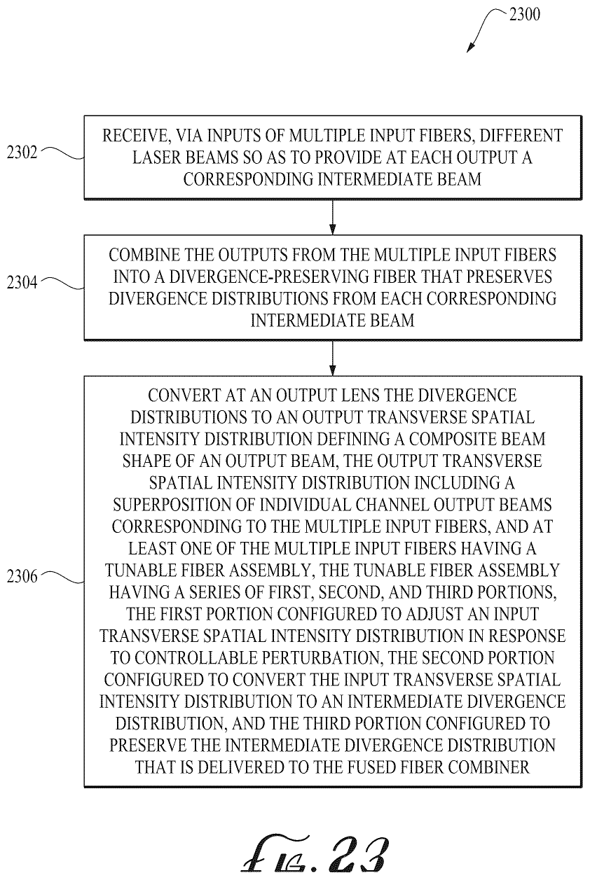

Because a core of a source fiber 2108 is radially offset from the central optical axis of fiber assembly 2102, the amount of offset is converted to an angular offset of the divergence distribution, azimuthally scrambled, and converted back to a ring or saddle shape at the output, with the amount of offset being proportional to an outer diameter of the output beam. FIG. 22, for example, shows an example ring beam shape at the output. The ring beam shape may then be combined with outputs from different input fibers 1602, such as first input fiber 1604 or second input fiber 1606, so as to form composite beam shapes.

Skilled persons will appreciate that source fiber 2108 may be implemented with fiber bundle or multicore fiber, with different radial offsets (or no radial offset) providing for different size rings. In other embodiments, divergence-preserving fibers may include a non-circular core or microbends to facilitate mode scrambling. Other optimizations, such as the CLS and FFC/FFS options are also possible.

FIG. 23 shows a process 2300 of generating adjustable composite beam shapes in response to controllable perturbation. In block 2302, process 2300 receives, via inputs of multiple input fibers, different laser beams so as to provide at each output a corresponding intermediate beam. In block 2304, process 2300 combines the outputs from the multiple input fibers into a divergence-preserving fiber that preserves divergence distributions from each corresponding intermediate beam. In block 2306, process 2300 converts at an output lens the divergence distributions to an output transverse spatial intensity distribution defining a composite beam shape of an output beam, the output transverse spatial intensity distribution including a superposition of individual channel output beams corresponding to the multiple input fibers, and at least one of the multiple input fibers having a tunable fiber assembly, the tunable fiber assembly having a series of first, second, and third portions, the first portion configured to adjust an input transverse spatial intensity distribution in response to controllable perturbation, the second portion configured to convert the input transverse spatial intensity distribution to an intermediate divergence distribution, and the third portion configured to preserve the intermediate divergence distribution that is delivered to the fused fiber combiner.

Having described and illustrated the general principles of examples of the presently disclosed technology, it should be apparent that the examples may be modified in arrangement and detail without departing from such principles. Skilled persons, therefore, will appreciate that many changes may be made to the details of the above-described embodiments without departing from the underlying principles of the invention. The scope of the present invention should, therefore, be determined only by the following claims.

1. A method of generating adjustable composite beam shapes in response to controllable perturbation, the method comprising:
receiving, via inputs of multiple input fibers, different laser beams so as to provide at each output a corresponding intermediate beam;
combining the outputs from the multiple input fibers into a divergence-preserving fiber that preserves a combined divergence distribution of the intermediate beams; and
converting at an output lens the combined divergence distribution to an output transverse spatial intensity distribution defining a composite beam shape of an output beam, the output transverse spatial intensity distribution including a superposition of individual channel output beams corresponding to the multiple input fibers, and at least one of the multiple input fibers having a tunable fiber assembly, the tunable fiber assembly having a series of first, second, and third portions, the first portion configured to adjust an input transverse spatial intensity distribution in response to controllable perturbation, the second portion configured to convert the input transverse spatial intensity distribution to an intermediate divergence distribution, and the third portion configured to preserve the intermediate divergence distribution that is delivered to the fused fiber combiner.

2. The method of claim 1, further comprising modulating the output transverse spatial intensity distribution based on an amount of perturbation applied according to a predetermined frequency.

3. The method of claim 1, further comprising modulating power applied to at least one of the multiple input fibers.

4. The method of claim 1, further comprising applying time-dependent power to different sets of the multiple input fibers so as to change the composite shape as a function of time.

5. The method of claim 1, in which the divergence-preserving fiber includes a splice.

6. The method of claim 5, in which the tunable fiber assembly includes a splice.

7. The method of claim 5, in which the splice steps up or down a diameter of one or both a core and a cladding of the divergence-preserving fiber.

8. The method of claim 1, in which the divergence-preserving fiber includes an FFC or an FFS, thereby establishing an input divergence-preserving fiber, an output divergence-preserving fiber, and the FFC or the FFS therebetween.

9. The method of claim 8, in which one or both of a core and a cladding of the input divergence-preserving fiber to the FFC or the FFS is smaller or larger than one or both of a core and a cladding of the output divergence-preserving fiber from the FFC or the FFS.

10. The method of claim 1, in which the divergence-preserving fiber includes one or more cladding light strippers (CLSs).

11. The method of claim 1, in which the tunable fiber assembly includes one or more cladding light strippers (CLSs).

12. The method of claim 1, further comprising a mode-distribution homogenization portion of at least one of the multiple input fibers.

13. The method of claim 12, in which a non-circular core fiber, an offset splice a coil, one or more macro-bends, or one or more micro-bends provides the mode-distribution homogenization portion.
